(19) United States
(12) Patent Application Publication
(10) Pub. No.: US 2021/0291953 A1
(43) Pub. Date: Sep. 23, 2021

(54) Flight Vehicle Structural Components, and Flight Vehicles Including the Same

(71) Applicant: Birmingham Technologies, Inc., Arlington, VA (US)

(72) Inventor: Joseph Birmingham, Arlington, VA (US)

(73) Assignee: Birmingham Technologies, Inc., Arlington, VA (US)

(21) Appl. No.: 16/817,112

(22) Filed: Mar. 12, 2020

(51) Int. Cl. B64C 1/12; B32B 5/26

(52) U.S. Cl. CPC B64C 1/12; B32B 5/26; B64C 39/024; B32B 2262/106; B32B 2307/202

(57) ABSTRACT

Embodiments relate to a flight vehicle structural component for nano-scale energy converters and thermionic power harvesting devices. The apparatus includes a first electrode, a second electrode spaced from the first electrode to provide an inter-electrode gap between the first and second electrodes, and a plurality of nanoparticles suspended in a medium contained in the inter-electrode gap, the nanoparticles arranged in the inter-electrode gap to permit electron transfer between the first electrode and the second electrode. The flight vehicle structural component is operable as an energy harvesting device and configured to define a skin, a portion of the skin, a structural support, or a portion of the structural support of a flight vehicle.

### BACKGROUND

The present embodiments relate to flight vehicle structural components for electric power generation, conversion, and transfer, and to flight vehicle structural components incorporated into a flight vehicle. More specifically, the embodiments disclosed herein are related to a nano-scale energy conversion flight vehicle structural component that generates electric power through thermionic energy conversion and thermoelectric energy conversion, and to such structural components integrated into a flight vehicle.

Flight vehicles, particularly small unmanned air vehicle systems (SUAS) useful for air-borne operations, use onboard stored electrical energy and electric drive for mission execution and performance. The current method of deploying such flight vehicles involves equipping the flight vehicles with solar-powered batteries, or with the batteries that are fully charged prior to deployment. Often, the power of the SUAS is or has been depleted before the mission is completed. Solar-powered battery operation can be hampered by adverse weather conditions. Alternatively, the SUAS can be equipped with power systems based on electrochemical technologies such as lithium-ion, lead-acid, or nickel-cadmium batteries. However, such battery technologies are constrained because they often use hazardous materials that provide limited battery life.

### SUMMARY

The embodiments include flight vehicle structural components to generate electric power on a nanometer scale, flight vehicles (especially small unmanned aircraft systems such as SUAS) including one or more of the flight vehicle structural components, and methods of making and using the same.

In an aspect, a flight vehicle structural component includes a first electrode, a second electrode spaced from the first electrode to provide an inter-electrode gap between the first and second electrodes, and a plurality of nanoparticles suspended in a medium contained in the inter-electrode gap and arranged to permit ion transfer between the first and second electrodes. The flight vehicle structural component is operable as an energy harvesting device and configured to define a skin, a portion of the skin, a structural support, or a portion of the structural support of a flight vehicle.

In another aspect, a flight vehicle structural component integrated into a flight vehicle, especially a SUAS in exemplary embodiments, is provided. The flight vehicle structural component includes a first electrode, a second electrode spaced from the first electrode to provide an inter-electrode gap between the first and second electrodes, and a plurality of nanoparticles suspended in a medium contained in the inter-electrode gap and arranged to permit ion transfer between the first and second electrodes. The flight vehicle structural component is operable as an energy harvesting device.

In yet another aspect, an energy harvesting device includes a first graphene electrode coated with a first layer comprised of a first material to provide the coated first graphene electrode with a first work function value, a second graphene electrode spaced from the first graphene electrode to provide an inter-electrode gap between the first and second graphene electrodes, the second graphene electrode coated with a second layer comprised of a second material that is different than the first material to provide the coated second graphene electrode with a second work function value that is different than the first work function value, and a plurality of nanoparticles suspended in a medium contained in the inter-electrode gap, the nanoparticles arranged in the inter-electrode gap to permit ion transfer between the first graphene electrode and the second graphene electrode.

These and other features and advantages will become apparent from the following detailed description of the presently exemplary embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments, unless otherwise explicitly indicated.

FIG. 1 is a top perspective, partially see-through view of an aircraft wing frame including a plurality of internal struts serving as a nano-scale energy harvesting structural component according to an embodiment of the invention.

FIG. 2 is a bottom perspective, sectional view of an aircraft wing skin including a nano-scale energy harvesting structural component according to an embodiment of the invention.

FIG. 3 depicts a flight vehicle including a nano-scale energy harvesting structural component according to an embodiment of the invention.

FIG. 4 depicts a sectional view of one embodiment of a flight vehicle structural component for nano-scale energy harvesting.

FIG. 5A depicts a top view of one embodiment of a spacer and adjacent electrodes for use in a nano-scale energy device.

FIG. 5B depicts a top view of one embodiment of a spacer and adjacent electrodes for use in a nano-scale energy device.

FIG. 6 depicts a schematic view of one embodiment of a nano-fluid including a plurality of nanoparticle clusters suspended in a dielectric medium.

FIG. 7 depicts a schematic perspective view of a thermionic power harvesting device.

FIG. 8 depicts a perspective view of a thermionic power harvesting device.

FIG. 9 depicts a perspective view of a first repository of layered materials that may be used to manufacture the thermionic power harvesting device.

FIG. 10 depicts a perspective view of a second repository of layered materials that may be used to manufacture the thermionic power harvesting device.

FIG. 11A depicts an enlarged perspective, sectional and fragmented view of a first portion of the energy harvesting device.

FIG. 11B is a fragmented cross-sectional view of box 11B of FIG. 11A depicting part of the energy harvesting device of FIG. 11A.

FIG. 12 depicts a flow chart illustrating a process for generating electric power with the thermionic energy harvesting device.

FIG. 13 depicts an electrospray technique suitable for exemplary embodiments of the invention.

FIG. 14 depicts integration of a nano-scale energy harvesting device with solar cells arranged in an array.

### DETAILED DESCRIPTION OF EXEMPLARY EMBODIMENTS

It will be readily understood that the components of the present embodiments, as generally described and illustrated in the Figures herein, may be arranged and designed in a wide variety of different configurations. Thus, the following detailed description of the embodiments of the apparatus, system, and method of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment. The embodiments may be combined with one another in various combinations.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Exemplary embodiments of the invention are directed to thermionic aircraft components and other thermionic aerodynamic components, especially those used in small unmanned air systems (SUAS), and especially to those in which the components are incorporated into the aircraft as a structural component or element. Such structural components and elements include wings, fuselage, and airframe parts to provide both power production and structural integrity to support flight operations. For example, the thermionic aircraft components can be self-charging or autogenous by harvesting energy from various energy sources, such as ambient heat, heat generated by solar reflection against the aircraft or aircraft parts such as solar cells, and/or heat generated by the impingement of air against the aircraft, such as a leading edge of the aircraft wings or the nose of the aircraft.

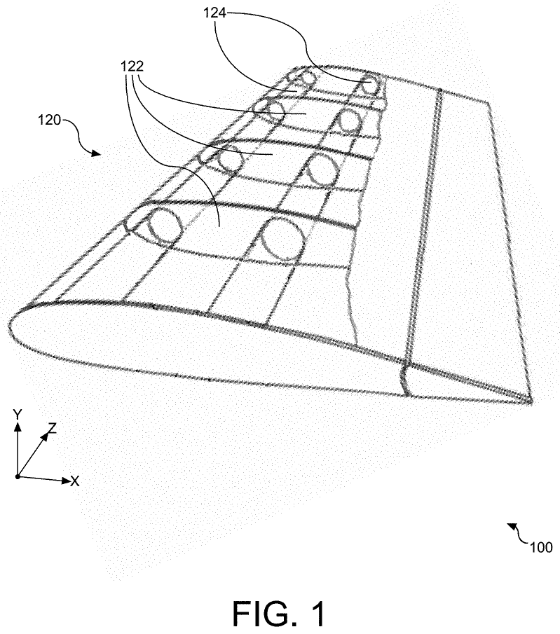

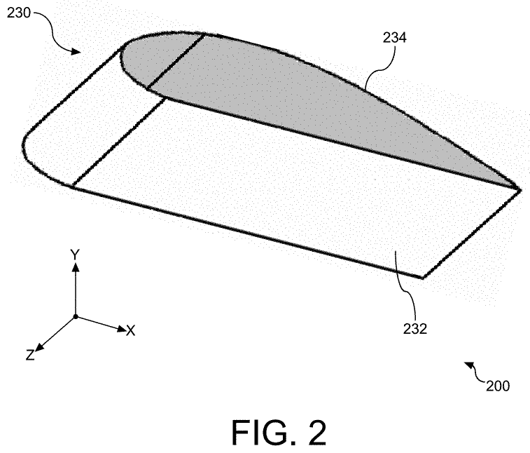

Referring now more particularly to the drawings, a framework for an aircraft wing is generally designated by reference numeral (120) in FIG. 1 and a shell or skin for an aircraft wing is generally designated by reference numeral (130) in FIG. 2. The aircraft wing framework (120) includes a plurality of flight vehicle structural components in the form of a plurality of struts (122) configured as airfoils or having airfoil shapes. The struts (122) are spaced apart from one another in a lateral direction “Z”. Connecting rods (124) extending in the Z-direction connect the spaced struts (122) to one another. The shell or skin (230) of FIG. 2 has an airfoil shape corresponding to the outer edges of the aircraft wing framework (120).

The struts (122) and the skin (230) have an airfoil-shape, so that the resultant wing produces aerodynamic force as a flight vehicle comprising the wing travels through the air to create lift. In FIGS. 1 and 2, the struts (122) and the skin (130) have a planar or relatively planner bottom edge (232) and curved or non-planar top edge (234). In an embodiment, the top edge (number 234) has a teardrop profile or shape. The struts (122) and the skin (230) can have various airfoil shapes, including combinations of a flat bottom, a curved bottom, a flat top, and a curved top, etc., and as such, the shapes shown herein should not be considered limiting. In an embodiment, the struts (122) and the skin (230) can have a symmetrical top and bottom.

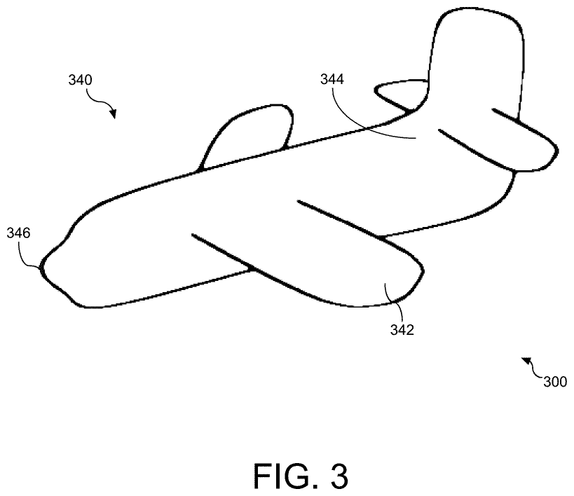

The struts (122) and/or the skin (230) are structured as energy harvesting devices to provide an electrical power source for the flight vehicle or components of the flight vehicle. Energy harvesting devices suitable for making the struts (122) and the skin (230) are described in further detail below. As will become clearer from the detailed description below, the struts (122) may comprise, for example, a plurality of energy harvesting devices having a sheet-like configuration stacked on one another, such as by three-dimensional/four-dimensional printing of the struts (122), and the skin (230) may comprise one or more of the sheet-like energy harvesting devices wrapped around the framework (120) one, two, three, four, or more times. Referring to FIG. 3, it should be understood that the energy harvesting devices described herein may be used as various components of an aircraft (340), including the front and/or rear wings (342), the fuselage (344), and the nose (346). FIG. 3 shows the aircraft (340) having a shape similar to that of a conventional airplane. However, it is understood in that art that aerodynamic vehicles may have different shapes. It should be understood that the principles of the present invention may be applied to other types of SUAS, including but not limited to, an unmanned aerial vehicle (UAV), an unmanned aerial system (UAS), or in an embodiment various forms of projectiles, such as missiles. Specific examples include, without limitation Group I, Group II, Group III, and Group III SUAS, such as the RQ-11 Raven and Puma AE (All Environment) of AeroVironment, Inc., and predator and global hawk systems.

Thermoelectric/thermionic power conversion of thermionic aircraft components such as the struts (122) illustrated in FIG. 1 and the skin (230) illustrated in FIG. 2 presents an avenue to harvest and convert thermal energy into electricity during flight, including during flight for prolonged periods that are longer than capable with conventional batteries. Thermoelectric power generation involves the operative association of a first electrode and a second electrode to form a junction therebetween where the at least two electrodes experience a temperature gradient. Based on the quantum mechanical effect, the connected dissimilar metals induces a voltage. Higher temperature differentials tend to produce higher voltages and electric currents. However, due to the transfer of heat between the two materials at the junction, a thermal backflow is introduced which reduces an efficiency of thermoelectric power conversion systems.

Generally, thermionic power conversion presents an avenue to convert thermal energy into electrical energy. Thermoelectric power conversion generators convert thermal energy to electrical energy by an emission of electrons from a heated emitter electrode (i.e., a cathode). Electrons flow from an emitter electrode, across an inter-electrode gap, to a collector electrode (i.e., an anode), through an external load, and return back to the emitter electrode, thereby converting heat to electrical energy. Recent improvements in thermionic power converters pertain to material selection based on work functions and corresponding work function values for the electrodes and using a fluid to fill the inter-electrode gap. Electron transfer density is limited by the materials of the electrodes and the materials of the fluid in the inter-electrode gap (i.e., the associated work functions).

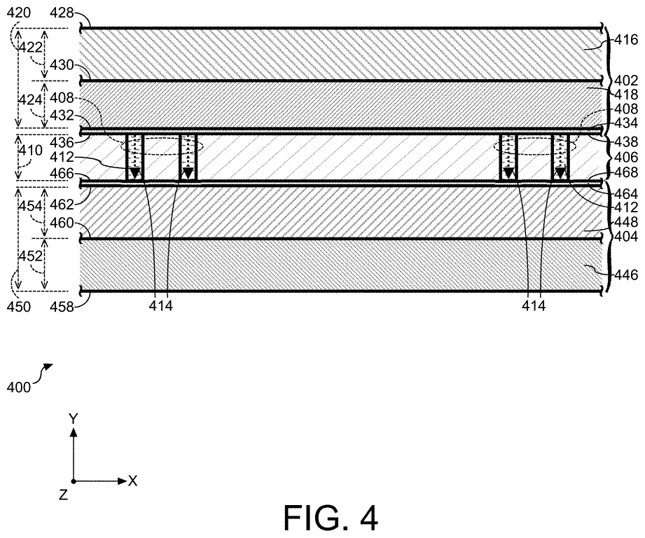

To provide additional details for an improved understanding of selected embodiments of the present disclosure that combine the use of thermoelectric and thermionic power conversion, reference is now made FIG. 4 illustrating a sectional view of an embodiment of a nano-scale energy harvesting device (400) that is configured to generate electrical power. Each of the dimensions, including a thickness dimension defined parallel to a first-axis, also referred to herein as a vertical axis, i.e. Y-axis in FIG. 4, a longitudinal dimension parallel to a second-axis, i.e., X-axis in FIG. 4, also referred to herein as a horizontal axis, and a lateral dimension parallel to a third axis-axis, i.e. Z-axis in FIG. 4, orthogonal to the first-axis and second axis, are shown for reference. The X-axis, Y-axis, and Z-axis are orthogonal to each other in physical space.

The nano-scale energy harvesting device (400) is sometimes referred to herein as a cell. In exemplary embodiments, the nano-scale energy harvesting device (400) is illustrated as a sheet or a plurality of adjacently positioned sheets. A plurality of devices (400) may be organized as a plurality of cells, or a plurality of layers, with the cells or layers arranged in series or parallel, or a combination of both to generate electrical power at the desired voltage, current, and power output.

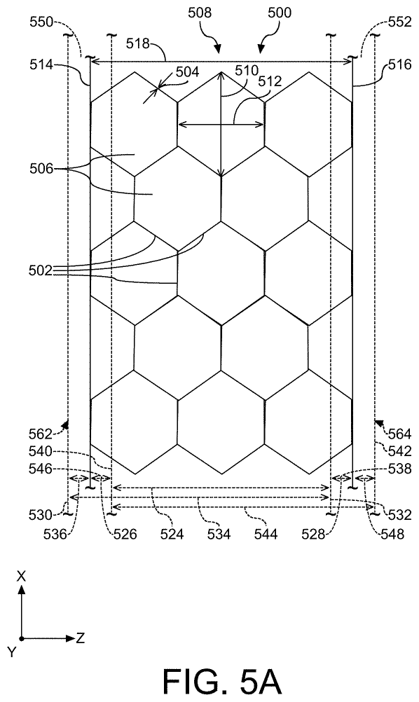

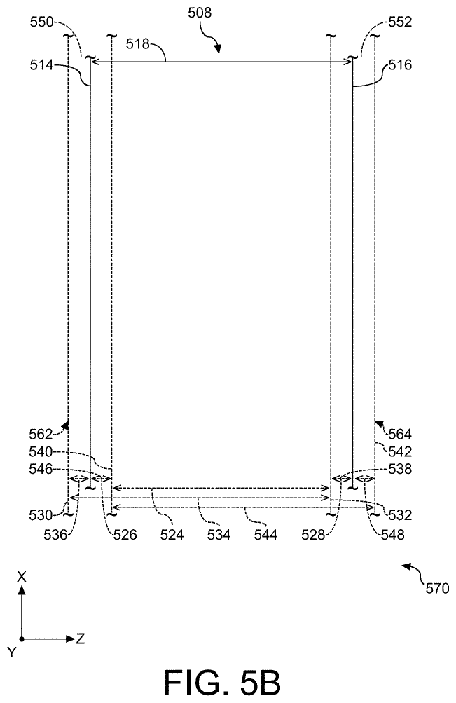

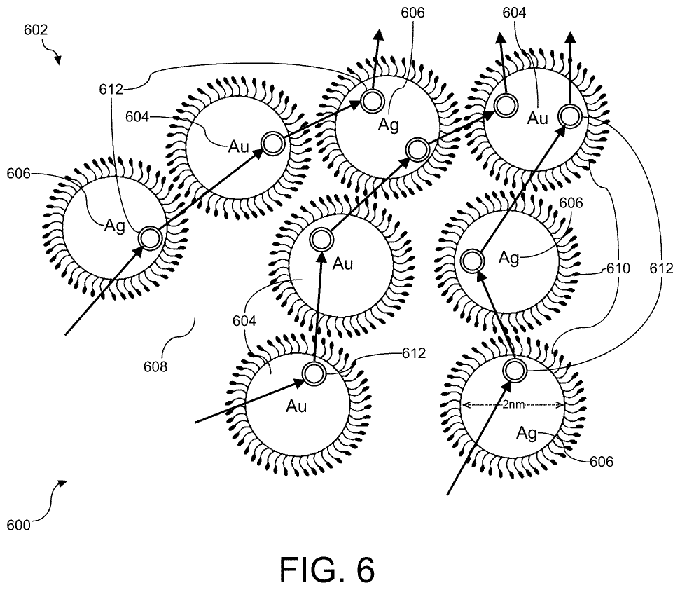

The nano-scale energy harvesting device (400) includes an emitter electrode (also referred to herein as the cathode) (402) and a collector electrode (also referred to herein as the anode) (404) positioned to define an inter-electrode gap (or interstitial space) (440) therebetween. In an embodiment, a spacer (406) of separation material, sometimes referred to herein as a standoff or spacer, maintains separation between the electrodes (402) and (404). While the spacer (406) is referred to herein in the singular, it should be understood that the spacer (406) may comprise a plurality of elements. The spacer (406) may be an insulator or comprise one or more materials that collectively exhibit non-conductive properties. The spacer (406) is illustrated in direct contact with the electrodes (402) and (404). The electrodes (402) and (404) and the spacer (406) define a plurality of closed apertures (408), also referred to herein as cavities (discussed further below with respect to FIGS. 5A and 5B), in the inter-electrode gap (440). The apertures (408) extend in the Y direction between the electrodes (402) and (404) for a distance (410) in the range, for example, of about 1 nanometer (nm) to about 100 nm, or in the range, for example, of about 1 nm to about 20 nm. A fluid (412), also referred to as a nano-fluid (discussed further herein with reference to FIG. 6), is received and maintained within each aperture (408).

In alternative embodiments, no spacer (406) is used and only the nano-fluid (412) is positioned between the electrodes (402) and (404). Accordingly, the nano-scale energy harvesting device (400) includes two opposing electrodes (402) and (404), optionally separated by the spacer (406) with a plurality of apertures (408) extending between the electrodes (402) and (404) and configured to receive the nano-fluid (412).

The emitter electrode (402) and the collector electrode (404) each may be fabricated from different materials, with the different materials having separate and different work function values. The work function of a material or a combination of materials is the minimum thermodynamic work, i.e., minimum energy, needed to remove an electron from a solid to a point in a vacuum immediately outside a solid surface of the material. The work function is a material-dependent characteristic. Work function values are typically expressed in units of electron volts (eV). Accordingly, the work function of a material determines the minimum energy required for electrons to escape the surface, with lower work functions generally facilitating electron emission.

The difference in work function values between the electrodes (402) and (404) due to the different electrode materials is essentially the voltage that can be achieved. Thus, to generate high power, the difference in work function values between the electrodes (402) and (404) is large in an exemplary embodiment. In an exemplary embodiment, the work function value of the collector electrode (404) is smaller than the work function value of the emitter electrode (402). The different work function values induces a contact potential difference between the electrodes (402) and (404) that has to be overcome, e.g., by the application of heat to the emitter electrode (402), to transmit electrons through the fluid (412) within the apertures (408) from the emitter electrode (402) to the collector electrode (404). The total of the work function value of the collector electrode (404) and the contact potential difference is less than or equal to the work function of the emitter electrode (402) in an exemplary embodiment. Maximum flow occurs when the total of the work function value of the collector electrode (404) and the contact potential equals the work function of the emitter electrode (402).

Both electrodes (402) and (404) emit electrons; however, as explained in more detail elsewhere herein, once the contact potential difference is overcome, the emitter electrode (402) will emit significantly more electrons than the collector electrode (404). A net flow of electrons will be transferred from the emitter electrode (402) to the collector electrode (404), and a net electron current (414) will flow from the emitter electrode (402) to the collector electrode (404) through the apertures (408). This net electron current (414) causes the emitter electrode (402) to become positively charged and the collector electrode (404) to become negatively charged. Accordingly, the nano-scale energy harvesting device (400) generates an electron current (414) that is transmitted from the emitter electrode (402) to the collector electrode (404).

The emitter electrode (402) may be manufactured with a first backing (416), which may comprise, for example, a polyester film, e.g., Mylar®, and a first layer (418) extending over the first backing (416). The first layer (418) may be comprised of graphene, platinum (Pt), or other suitable materials. The emitter electrode (402) has an emitter electrode thickness measurement (420) extending in the Y direction that is, for example, approximately 0.25 millimeters (mm), such measurement being non-limiting, or in a range of, for example, about 2 nm to about 0.25 mm, such measurements being non-limiting. The first backing (416) is shown in FIG. 4 with a first backing thickness measurement (422), and the first layer (418) is shown herein with a first layer thickness measurement (424), each extending in the Y direction. The first backing thickness measurement (422) and the first layer thickness measurement (424) range of, for example, about 0.01 mm to about 0.125 mm, or, for example, 0.125 mm, such values being non-limiting. The first backing measurement (422) and the first layer measurement (424) may have the same or different measurement values.

In exemplary embodiments, the first layer (418) is sprayed onto the first backing (416) so as to embody the first layer (418) as a nanoparticle layer that is approximately 2 nm (i.e., the approximate length of a nanoparticle), where the 2 nm value should be considered non-limiting. The first layer (418) may range from, for example, about 1 nm to about 20 nm. The first backing (416) has a first outer surface (428). The first backing (416) and the first layer (or the nanoparticle layer) (418) define a first interface (430). The first layer (or the nanoparticle layer) (418) defines a first surface (432) facing the inter-electrode gap (440). Alternatively, the first layer (418) may be pre-formed and applied to the first backing layer (416).

A first coating (434), such as cesium oxide (Cs₂O), covers at least part of and optionally the entirety of the first surface (432) to form an emitter surface (436) of the first electrode (402) that directly interfaces with a first spacer surface (438). Accordingly, the emitter electrode (402) of the embodiment illustrated in FIG. 4 includes a first layer (or nanoparticle layer) (418) on a first backing (416) and the first coating (434) on the first surface (432).

In FIG. 4, the collector electrode (404) includes a second backing (446), which may be comprised of a polyester film, and at least one second layer (448), which may be comprised of, for example, graphene or aluminum (Al), extending over the second backing (446). The collector electrode (404) has a collector electrode thickness measurement (450) extending in the Y direction that is, for example, approximately 0.25 millimeters (mm), such measurement being non-limiting, or in a range of, for example, about 2 nm to about 0.25 mm, such values being non-limiting. For example, a second backing measurement (452) of the second backing (446) and a second layer measurement (454) of the layer (448) are each approximately 0.125 mm, such values being non-limiting. The second backing measurement (452) and the second layer measurement (454) may range from, for example, about 0.01 mm to about 0.125 mm, or each approximately 0.125 mm, such values being non-limiting. The second backing measurement (452) and the second layer measurement (454) may have the same or different measurement values.

In an embodiment, the second layer (448) is sprayed on to the second backing (446) to embody the second layer (448) as a second nanoparticle layer that is approximately 2 nm, where the 2 nm value should be considered non-limiting. Alternatively, the second layer (448) may be pre-formed and applied to the second backing (446). The second layer measurement (454) of the second layer (448) may range from, for example, approximately 1 nm to about 20 nm. The second backing (446) has a second outer surface (458). The second backing (446) and the second layer/nanoparticle layer (448) define a second interface (460). The second layer (or the second nanoparticle layer) (448) defines a second surface (462) facing the inter-electrode gap (440).

A second coating (464), which may be comprised of cesium oxide (Cs₂O), at least partially covers the second surface (462) to form a collector surface (466) of the collector electrode (404) that directly interfaces with a second surface (468) of the spacer (406). Accordingly, the collector electrode (404) of FIG. 4 includes the second layer/nanoparticle layer (448) on the second backing (446) and the Cs₂O coating (464) on the second surface (462).

The first coating (434) and the second coating (464) are formed on the first and second surfaces (432) and (462), respectively. In an embodiment, an electrospray or a nano-fabrication technique is employed to form or apply the first and second coatings (434) and (464), respectively. The first and second coatings (434) and (464) can be applied in one or more predetermined patterns that may be the same as or different from one another.

A percentage of coverage of each of the first surface (432) and second surface (462) with the respective (Cs₂O) coating layers (434) and (464) is within a range of at least 50%, and up to 70%, and in at least one embodiment is about 60%. The Cs₂O coatings (434) and (464) reduce the work function values of the electrodes (402) and (404) from the work function values of platinum (Pt), which is one embodiment is 5.65 electron volts (eV), and aluminum (Al), which in one embodiment is 4.28 eV. The emitter electrode (402) with the Cs₂O coating layer has a work function value ranging from about 0.5 to about 2.0 eV, and in an embodiment is approximately 1.5 eV, and the collector electrode (404) with the Cs₂O coating layer has a work function value of about 0.5 to about 2.0 eV, and in an embodiment is approximately 1.5 eV. In an embodiment, the electrodes (402) and (404) are comprised of graphene, and are referred to herein as graphene electrodes (402) and (404). The graphene electrodes (402) and (404) can exhibit work function values below 1.0 eV when coated with cesium oxide, gold, tungsten, and other elements and compounds. Sulfur may be incorporated into the coatings (434) and (464) to improve the bonding of the coating to the graphene electrodes (402) and (404), particularly where the electrodes are graphene and the sulfur creates covalent bonding between the electrodes (402) and (404) and their respective coatings (434) and (464). The respective work function values of the electrodes (402) and (404) can be made to differ, even when both are comprised of graphene, by applying different coatings (434) and (464) to the electrodes (402) and (404). Suitable graphene electrodes are available through ACS (Advanced Chemical Suppliers) Materials, and include Trivial Transfer Graphene™ (TTG 10055).

In an embodiment, the surface area coverage on the emitter electrode (402) or the collector electrode (404) with Cs₂O is spatially resolved, e.g. applied in a pattern or non-uniform across the length of the corresponding surface, and provides a reduction in a corresponding work function to a minimum value. In an exemplary embodiment, the work function value, from a maximum of about 2.0 eV is reduced approximately 60-80% corresponding to the surface coverage of the Cs₂O, e.g. cesium oxide. Accordingly, the lower work function values of the electrodes (402) and (404) improve operation of the nano-scale energy harvesting device (400) as described herein.

Platinum (Pt) and aluminum (Al) materials optionally are selected for the first and second electrodes (402) and (404), respectively, due to at least some of their metallic properties, e.g., strength and resistance to corrosion, and the measured change in work function values when the thermionic emissive material of Cs₂O is layered thereon. Alternative materials may be used, such as graphene, noble metals including, and without limitation, rhenium (Re), osmium (Os), ruthenium (Ru), tantalum (Ta), iridium (Ir), rhodium (Rh), and palladium (Pd), or any combination of these metals. In addition, and without limitation, non-noble metals such as gold (Au), tungsten (W), and molybdenum (Mo), and combinations thereof, may also be used. For example, and without limitation, tungsten (W) nanoparticles may be used rather than platinum (Pt) nanoparticles to form the first surface (432), and gold (Au) nanoparticles may be used rather than aluminum (Al) nanoparticles to form the second surface (462). Accordingly, the selection of the materials to use to form the nanoparticle surfaces (432) and (462) can be principally based on the work functions of the electrodes (402) and (404), and more specifically, the difference in the work functions once the electrodes (402) and (404) are fully fabricated.

The selection of the first and second coatings (434) and (464), e.g., thermionic electron emissive material, on the first surface (432) and second surface (462), respectively, may be partially based on the desired work function value of the electrodes (402) and (404), respectively, and chemical compatibility between the deposited materials, and the deposited thermionic electron emissive materials of the first and second coatings (434) and (464). Deposition materials include, but are not limited to, thorium, aluminum, cerium, and scandium, as well as oxides of alkali or alkaline earth metals, such as cesium, barium, calcium, and strontium, as well as combinations thereof and combinations with other materials. In at least one embodiment, the thickness of the layer of patterned thermionic electron emissive material of the first and second coatings (434) and (464) is approximately 2 nm, where the 2 nm value should be considered non-limiting. Accordingly, the electrodes (402) and (404) have the desired work functions.

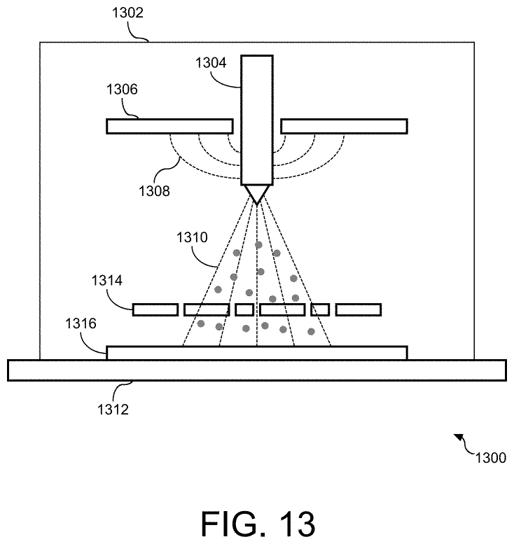

Exemplary electrospray and nano-fabrication technique(s) and associated equipment, including three-dimensional printing and four-dimensional printing (in which the fourth dimension is varying the nanoscale composition during printing to tailor properties) for forming the first layer/first nanoparticle layer (418), the second layer/second nanoparticle layer (448), the spacer (406) and other layers and coatings discussed herein, including those of the device (400), or the entire flight vehicle structure component or flight vehicle, are set forth in U.S. Application Publication No. 2015/0251213. Generally, that application discloses a composition including a nano-structural material, grain grow inhibitor nanoparticles, and at least one of a tailoring solute or tailoring nanoparticles. A simplified diagram of an electrospray apparatus or system is generally designated by reference numeral (1300) in FIG. 13. The electrospray system (1300) includes an outer housing (1302) that may be embodied as a vented heat shield containing a Faraday cage (not shown). Within the outer housing (1302), an emitter tube (also referred to as an electrospray nozzle) (1302) coupled to the bottom of a material reservoir (not shown) receives molten material from the material reservoir through a capillary tube (not shown). An extractor electrode (1306) is configured for generating an electric field (1308) to extract the molten material from the electrospray nozzle (1304) to form a stream or spray (1313) of droplets of nanoparticle size. The electric field (1308) also drives the spray of droplets (1310) towards a moving stage (1312) that is movable relative to the extractor electrode (1306). The extractor electrode (1306) can also generate a magnetic field for limiting dispersion of the stream (1310) of droplets. In an exemplary embodiment, the extractor electrode (1306) has a toroid shape, with the electrospray nozzle (1304) extending through the center of the toroid. FIG. 13 shows the use of a template (1314) for forming a predetermined pattern on a substrate (1316). For example, the substrate (1316) can be the emitter or collector electrode and the template (1314) can be used to controlling the deposition of the (cesium oxide) coating on the electrode (1316).

The composition contained in the material reservoir may include one or more nano-structural materials, one or more grain growth inhibitor nanoparticles, and at least one of a first tailoring solute and/or first tailoring nanoparticles.

FIG. 5A depicts a top view of an embodiment of a spacer (500), which is shown in solid (non-broken) lines, in relationship to the adjacent electrodes (562) and (564), which are shown in phantom (or broken lines) for use in a nano-scale energy device, such as the device (400) as shown and described in reference to FIG. 4. The spacer (500) and the electrodes (562) and (564) are not shown to scale.

The spacer (500) includes a plurality of interconnected edges (502). The edges (502) have a thickness or edge measurement (504) in the range of, for example, about 2.0 nm to about 0.25 mm. In the illustrated embodiment, the interconnected edges (502) collectively define a plurality of hexagonal apertures, also referred to herein as cavities (506), in a honeycomb array (508). The cavities (506) extend in a direction parallel to the Y-axis. The spacer (500) may be configured as a uniform or relatively uniform layer, e.g., contiguous and with or without limited apertures. The apertures or cavities, either uniformly or non-uniformly provided across the width and/or length of the spacer material, ranging from, for example, greater than 0 mm to about 0.25 mm in the Y-axis direction.

Referring to FIG. 5B, a top view of another embodiment of a spacer (570), shown in solid lines, and the adjacent electrodes (562) and (564), shown in phantom or broken lines, is shown for use in a nano-scale energy device, such as the device (400) as shown and described in FIG. 4. The embodiments shown and described in FIGS. 5A and 5B are provided with the same reference numerals, where appropriate, to designate identical or like parts. The spacer (570) may be comprised of a permeable or semi-permeable material, which in an embodiment may be adapted to receive or be coated or impregnated with the nano-fluid.

Referring to FIG. 5A, the apertures (506) have a first dimension (510) and a second dimension (512) each having a value in a range between, for example, 2.0 nm and 100 microns. In an embodiment, the edges (502), the apertures (506), and the array (508) form various shapes, configurations, and sizes, including the dimensions and sizing of the apertures (506), that enable operation of spacer (500) as described herein, including, without limitation, circular, rectangular, and elliptical apertures (506).

The spacers (500) and (570), shown in FIGS. 5A and 5B, respectively, include a first outer edge (514) and a second outer edge (516) that define the dimensions of the spacer (500), (570). The spacer (500), (570) has a distance measurement (518) in the lateral dimension (Z) between the lateral side edges (514) and (516) in a range of, for example, about 1 nm to about 10 microns.

As shown in FIGS. 5A and 5B, the electrodes (562) and (564) are offset in an opposing manner in the lateral dimension Z with respect to one another and to the spacer (500), (570). Specifically, the emitter electrode (562) includes opposite first and second lateral side edges (530) and (532) separated by a first distance (534), and the collector electrode (564) includes opposite third and fourth lateral side edges (540) and (542) separated by a second distance (544). The values of the first and second distances (534) and (544) may be the same or different from one another, and may be within a range of, for example, approximately 10 mm to approximately 2.0 m.

With respect to the first electrode (562), the first lateral side edge (530) extends in the lateral direction Z beyond the first lateral support side edge (514) of the spacer (500), (570) by a third distance (536), and the second lateral support side edge (516) of the spacer (500), (570) extends in the lateral direction Z beyond the second lateral side edge (532) by a fourth distance (528).

With respect to the second electrode (564), the first lateral support side edge (514) of the spacer (500), (570) extends in the lateral direction Z beyond the third lateral side edge (540) by a fifth distance (526), and the fourth lateral side edge (542) extends in the lateral direction Z beyond the second lateral support side edge (516) of the spacer (500), (570) by a sixth distance (548).

The third distance (536), the fourth distance (528), the fifth distance (526), and the sixth distance (548) may be the same or different from one another and within a range of, for example, approximately 1.1 nm to approximately 10 microns. The spacer (500), (570) may have a lateral measurement (518) with respect to the Z-axis greater than lateral measurements (534) and (544) of the electrodes (562) and (564), respectively. The spacer measurements shown and described herein reduce a potential for electrodes, such as the electrodes (402) and (404) when the spacer is incorporated into the device (400) of FIG. 4, directly contacting one another, which direct contact would create a short circuit.

Each of the lateral support side edges (514) and (516) may receive at least one layer of an electrically insulative sealant that electrically isolates the portions (550) and (552) of the electrodes (562) and (564), respectively, that extend beyond the lateral support side edges (514) and (516), respectively. Accordingly, each of the electrodes (562) and (564) may be offset from the spacer (500), (570) to reduce the potential for the electrodes (562) and (564) contacting each other and creating a short circuit therebetween.

The spacers (500) and (570), also referred to herein as dielectric spacers, as shown and described in FIGS. 5A and 5B, respectively, are fabricated with a dielectric material, such as, and without limitation, silica (silicon dioxide), alumina (aluminum dioxide), titania (titanium dioxide), and boron-nitride. The apertures (506) extend between the electrodes (562) and (564) for the distance (410) (with reference to FIG. 4), e.g., in the Y-dimension, in a range from about 1 nanometer (nm) to about 10 microns. A fluid, e.g., the nano-fluid (412) of FIG. 4, is received and maintained within each of the apertures (506). The dielectric spacer (500), (570) is positioned between, and in direct contact with, the electrodes (562) and (564).

Referring to FIG. 6, a diagram (600) is provided to illustrate a schematic view of an embodiment of a fluid (602), also referred to herein as a nano-fluid. As shown, the nano-fluid (602) includes a plurality of gold (Au) nanoparticle clusters (604) and a plurality of silver (Ag) nanoparticle clusters (606) suspended in a dielectric medium (608). In some embodiments, and without limitation, the dielectric medium (608) is an alcohol, a ketone (e.g., acetone), an ether, a glycol, an olefin, and/or an alkane (e.g., those alkanes with greater than three carbon atoms, e.g., tetradecane). In an embodiment, the dielectric medium (608) is water or silicone oil. Alternatively, the dielectric medium (608) is a sol-gel with aerogel-like properties and low thermal conductivity values that reduce heat transfer therethrough, e.g., thermal conductivity values as low as 0.013 watts per meter-degrees Kelvin (W/m-K) as compared to the thermal conductivity of water at 20 degrees Celsius (° C.) of 0.6 W/m-K. Appropriate materials are selected prior to fabricating the nanoparticle clusters (604) and (606). The materials selected for the nanoparticle clusters (604) and (606) should have work function values that are greater than the work function values for associated electrodes, such as the electrodes (402) and (404) of FIG. 4. For example, the work function values of the Au nanoparticle clusters (604) and the Ag nanoparticle clusters (606) are about 4.1 eV and 3.8 eV, respectively.

At least one layer of a dielectric coating (610), such as a monolayer of alkanethiol material, is deposited on the Au nanoparticle clusters (604) and the Ag nanoparticle clusters (606) to form a dielectric barrier thereon. In an exemplary embodiment, the deposit of the dielectric coating (610) is via electrospray. The alkanethiol material of the dielectric coating (610) includes, but is not limited to, dodecanethiol and/or decanethiol. The deposit of the dielectric coating (610), such as alkanethiol, reduces coalescence of the nanoparticle clusters (604) and (606). In at least one embodiment, the nanoparticle clusters (604) and (606) have a diameter in the range of about 1 nm to about 3 nm. In an exemplary embodiment, the nanoparticle clusters (604) and (606) have a diameter of about 2 nm. The Au nanoparticle clusters (604) and the Ag nanoparticle clusters (606) are tailored to be electrically conductive with charge storage features (i.e., capacitive features), minimize heat transfer through associate spacer apertures, such as the spacer apertures (506) of FIG. 5A, with low thermal conductivity values, minimize ohmic heating, eliminate space charges in the spacer apertures (506), and prevent arcing. The plurality of Au nanoparticle clusters (604) and the Ag nanoparticle clusters (606) are suspended in the dielectric medium (608). Accordingly, the nano-fluid (602), including the suspended nanoparticle clusters (604) and (606), provides a conductive pathway for electrons to travel across the spacer apertures (506) from, for example with reference to FIG. 4, the emitter electrode (402) to the collector electrode (404) through charge transfer. Accordingly, in at least one embodiment, a plurality of the Au nanoparticle clusters (604) and the Ag nanoparticle clusters (606) are mixed together in the dielectric medium (608) to form the nano-fluid (602), the nano-fluid (602) residing in the apertures (408) of FIG. 4 and/or the apertures (506) of FIG. 5A.

The Au nanoparticle clusters (604) according to exemplary embodiments are dodecanethiol functionalized gold nanoparticles, with an average particle size of about 1 nm to about 3 nm, at about 2% (weight/volume (grams/ml)). The Ag nanoparticle clusters (606) are dodecanethiol functionalized silver nanoparticles, with an average particle size of about 1 nm to about 3 nm, at about 0.25% (weight/volume percent). In an embodiment, the average particle size of both the Au and Ag nanoparticle clusters (604) and (606) is at or about 2 nm. The Au and Ag cores of the nanoparticle clusters (604) and (606) are selected for their abilities to store and transfer electrons. In an embodiment, a 50%-50% mixture of Au and Ag nanoparticle clusters (604) and (606) are used. However, a mixture in the range of 1-99% Au-to-Ag could be used as well. Electron transfers are more likely to occur between nanoparticle clusters (604) and (606) with different work functions. In an exemplary embodiment, a mixture of nearly equal (molar) numbers of two different nanoparticle clusters (604) and (606), e.g., Au and Ag, provides good electron transfer. Accordingly, nanoparticle clusters are selected based on particle size, particle material (with the associated work function values), mixture ratio, and electron affinity.

Conductivity of the nano-fluid (602) can be increased by increasing concentration of the nanoparticle clusters (604) and (606). The nanoparticle clusters (604) and (606) may have a concentration within the nano-fluid (602) of, for example, about 0.1 mole/liter to about 2 moles/liter. In at least one embodiment, the Au and Ag nanoparticle clusters (604) and (606) each have a concentration of at least 1 mole/liter. Accordingly, in at least one embodiment, a plurality of Au and Ag nanoparticle clusters (604) and (606) are mixed together in a dielectric medium (608) to form a nano-fluid (602), the nano-fluid (602) residing in, for example, the apertures (408) of FIG. 4 and/or the apertures (506) of FIG. 5A.

The stability and reactivity of colloidal particles, such as Au and Ag nanoparticle clusters (604) and (606), are determined largely by a ligand shell formed by the alkanethiol coating (610) adsorbed or covalently bound to the surface of the nanoparticle clusters (604) and (606). The nanoparticle clusters (604) and (606) tend to aggregate and precipitate, which can be prevented by the presence of a ligand shell of the non-aggregating polymer alkanethiol coating (610) enabling these nanoparticle clusters (604) and (606) to remain suspended. Adsorbed or covalently attached ligands can act as stabilizers against agglomeration and can be used to impart chemical functionality to the nanoparticle clusters (604) and (606). Over time, the surfactant nature of the ligand coatings is overcome and the lower energy state of agglomerated nanoparticle clusters is formed. Therefore, over time, agglomeration may occur due to the lower energy condition of nanoparticle cluster accumulation and occasional addition of a surfactant may be used. Examples of surfactants include, without limitation, Tween® 20 and Tween® 21.

In the case of the nano-fluid (600) of FIG. 6 substituted for the nano-fluid (412) of FIG. 4, electron transfer through collisions of the plurality of nanoparticle clusters (604) and (606) is illustrated. The work function values of the nanoparticle clusters (604) and (606) are much greater than the work function values of the emitter electrode (402) (about 0.5 eV to about 2.0 eV) and the collector electrode (404) (about 0.5 eV to about 2.0 eV). The nanoparticle clusters (604) and (606) are tailored to be electrically conductive with capacitive (i.e., charge storage) features while minimizing heat transfer therethrough. Accordingly, the suspended nanoparticle clusters (604) and (606) provide a conductive pathway for electrons to travel across the apertures (408) from the emitter electrode (402) to the collector electrode (404) through charge transfer.

Thermally-induced Brownian motion causes the nanoparticle clusters (604) and (606) to move within the dielectric medium (608), and during this movement the nanoparticle clusters (604) and (606) occasionally collide with each other and with the electrodes (402) and (404). As the nanoparticle clusters (604) and (606) move and collide within the dielectric medium (608), the nanoparticle clusters (604) and (606) chemically and physically transfer charge. The nanoparticle clusters (604) and (606) transfer charge chemically when electrons (612) hop from the electrodes (402) and (404) to the nanoparticle clusters (604) and (606) and from one nanoparticle cluster (604) and (606) to another nanoparticle cluster. The hops primarily occur during collisions. Due to differences in work function values, electrons (612) are more likely to move from the emitter electrode (402) to the collector electrode (404) via the nanoparticle clusters (604) and (606) rather than in the reverse direction. Accordingly, a net electron current from the emitter electrode (402) to the collector electrode (404) via the nanoparticle clusters (604) and (606) is the primary and dominant current of the nano-scale energy harvesting device (400).

The nanoparticle clusters (604) and (606) transfer charge physically (i.e., undergo transient charging) due to the ionization of the nanoparticle clusters (604) and (606) upon receipt of an electron, and the electric field generated by the differently charged electrodes (402) and (404). The nanoparticle clusters (604) and (606) become ionized in collisions when they gain or lose an electron (612). Positive and negative charged nanoparticle clusters (604) and (606) in the nano-fluid (602) migrate to the negatively charged collector electrode (404) and the positively charged emitter electrode (402), respectively, providing an electrical current flow. This ion current flow is in the opposite direction from the electron current flow, but less in magnitude than the electron flow.

Some ion recombination in the nano-fluid (602) may occur, which diminishes both the electron and ion current flow. Electrode separation may be selected at an optimum width to maximize ion formation and minimize ion recombination. In an exemplary embodiment, the electrode separation (410) is less than about 10 nm to support maximization of ion formation and minimization of ion recombination. The nanoparticle clusters (604) and (606) have a maximum dimension of, for example, about 2 nm. The electrode separation distance (410) as defined by the spacer (406) (or the spacer (500) or (570)) has an upper limit of, for example, about 20 nm, and the electrode separation distance (410) is equivalent to approximately 10 nanoparticle clusters (604) and (606). Therefore, the electrode separation distance (410) of about 20 nm provides sufficient space within the apertures (408) for nanoparticle clusters (604) and (606) to move around and collide, while minimizing ion recombination. For example, in an embodiment, an electron can hop from the emitter electrode (402) to a first set of nanoparticle clusters (604) and (606) and then to a second, third, fourth, or fifth set of nanoparticle clusters (604) and (606) before hopping to the collector electrode (404). A reduced quantity of hops mitigates ion recombination opportunities. Accordingly, ion recombination in the nano-fluid (602) is minimized through an electrode separation distance selected at an optimum width to maximize ion formation and minimize ion recombination.

When the emitter electrode (402) and the collector electrode (404) are initially brought into close proximity, the electrons of the collector electrode (404) have a higher Fermi level than the electrons of the emitter electrode (402) due to the lower work function of the collector electrode (404). The difference in Fermi levels drives a net electron current that transfers electrons from the collector electrode (404) to the emitter electrode (402) until the Fermi levels are equal, i.e., the electrochemical potentials are balanced and thermodynamic equilibrium is achieved. The transfer of electrons between the emitter electrode (402) and the collector electrode (404) results in a difference in charge between the emitter electrode (402) and the collector electrode (404). This charge difference sets up the voltage of the contact potential difference and an electric field between the emitter electrode (402) and the collector electrode (404), where the polarity of the contact potential difference is determined by the material having the greatest work function. With the Fermi levels equalized, no net current will flow between the emitter electrode (402) and the collector electrode (404). Accordingly, electrically coupling the emitter electrode (402) and the collector electrode (404) with no external load results in attaining the contact potential difference between the electrodes (402) and (404) and no net current flow between the electrodes (402) and (404) due to attainment of thermodynamic equilibrium between the two electrodes (402) and (404).

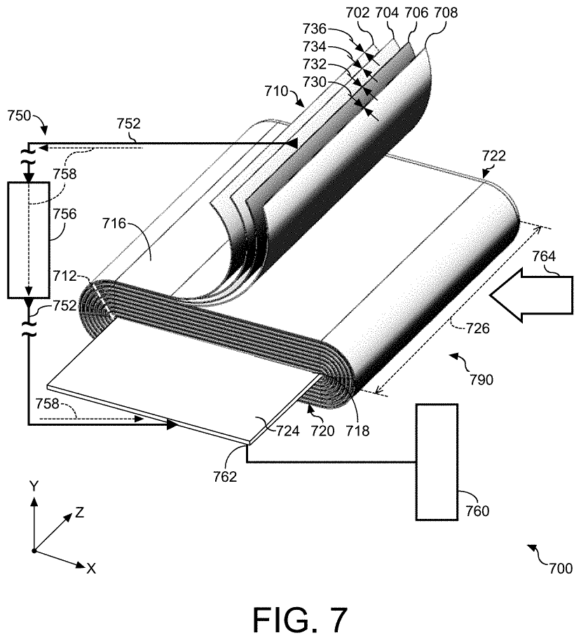

The nano-scale energy harvesting device (400) can generate electric power (e.g., at room temperature) with or without additional heat input. Heat added to the emitter electrode (402) will raise its temperature and the Fermi level of its electrons. With the Fermi level of the emitter electrode (402) higher than the Fermi level of the collector electrode (404), a net electron current will flow from the emitter electrode (402) to the collector electrode (404) through the nano-fluid (412), (602). If the device (400) is placed into an external circuit, as shown and described in FIG. 7, such that the external circuit is connected to the electrodes (402) and (404), the same amount of electron current will flow through the external circuit current from the collector electrode (404) to the emitter electrode (402). Heat energy added to the emitter electrode (402) is carried by the electrons (612) to the collector electrode (402). The bulk of the added energy is transferred to the external circuit for conversion to useful work, some of the added energy is transferred through collisions of the nanoparticle clusters (604) and (606) with the collector electrode (404), and some of the added energy is lost to ambient as waste energy. As the energy input to the emitter electrode (402) increases, the temperature of the emitter electrode (402) increases, and the electron transmission from the emitter electrode (402) increases, thereby generating more electron current. As the emitter electrode (402) releases electrons onto the nanoparticle clusters (604) and (606), energy is stored in the nano-scale energy harvesting device (400). Accordingly, the nano-scale energy harvesting device (400) generates, stores, and transfers charge and moves heat energy associated with a temperature difference, where added thermal energy causes the production of electrons to increase from the emitter electrode (402) into the nano-fluid (412), (602).

The nano-fluid (602) can be substituted into the device (400) of FIG. 4 and used to transfer charges from the emitter electrode (402) to one of the mobile nanoparticle clusters (604) and (606) via intermediate contact potential differences from the collisions of the nanoparticle cluster (604) and (606) with the emitter electrode (402) induced by Brownian motion of the nanoparticle clusters (604) and (606). Selection of dissimilar nanoparticle clusters (604) and (606) that include Au nanoparticle clusters (604) and Ag nanoparticle clusters (606) that have much greater work functions of about 4.1 eV and about 3.8 eV, respectively, than the work functions of the electrodes (402) and (404), improves transfer of electrons to the nanoparticle clusters (604) and (606) from the emitter electrode (402) to the collector electrode (404). This relationship of the work function values of the Au and Ag nanoparticle clusters (604) and (606) improves the transfer of electrons to the nanoparticle clusters (604) and (606) through Brownian motion and electron hopping. Accordingly, the selection of materials within the nano-scale energy harvesting device (400) improves electric current generation and transfer therein through enhancing the release of electrons from the emitter electrode (402) and the conduction of the released electrons across the nano-fluid (412), (602) to the collector electrode (404).

As the electrons (612) hop from nanoparticle cluster (604) and (606) to nanoparticle cluster (604) and (606), single electron charging effects that include the additional work required to hop an electron (612) onto a nanoparticle cluster (604) and (606) if an electron (612) is already present on the nanoparticle cluster (604) and (606), determine if hopping additional electrons (612) onto that particular nanoparticle cluster (604) and (606) is possible. Specifically, the nanoparticle clusters (604) and (606) include a voltage feedback mechanism that prevents the hopping of more than a predetermined number of electrons to the nanoparticle cluster (604) and (606). This prevents more than the allowed number of electrons (612) from residing on the nanoparticle cluster (604) and (606) simultaneously. In an embodiment, only one electron (612) is permitted on any nanoparticle cluster (604) and (606) at any one time. Therefore, during conduction of current through the nano-fluid (602), a single electron (612) hops onto the nanoparticle cluster (604) and (606). The electron (612) does not remain on the nanoparticle cluster (604) and (606) indefinitely, but hops off to either the next nanoparticle cluster (604) and (606) or the collector electrode (404) through collisions resulting from the Brownian motion of the nanoparticle clusters (604) and (606). However, the electron (612) does remain on the nanoparticle cluster (604) and (606) long enough to provide the voltage feedback required to prevent additional electrons (612) from hopping simultaneously onto the nanoparticle clusters (604) and (606). The hopping of electrons (612) across the nanoparticle clusters (604) and (606) avoids resistive heating associated with current flow in a media. Notably, the nano-scale energy harvesting device (400) containing the nano-fluid (602) does not require pre-charging by an external power source in order to introduce electrostatic forces. This is due to the device (400) being self-charged with triboelectric charges generated upon contact between the nanoparticle clusters (604) and (606) due to Brownian motion. Accordingly, the electron hopping across the nano-fluid (602) is limited to one electron (612) at a time residing on a nanoparticle cluster (604) and (606).

As the electrical current starts to flow through the nano-fluid (602), a substantial energy flux away from the emitter electrode (402) is made possible by the net energy exchange between emitted and replacement electrons (612). The replacement electrons from an electrical conductor connected to the emitter electrode (402) do not arrive with a value of energy equivalent to an average value of the Fermi energy associated with the material of emitter electrode (402), but with an energy that is lower than the average value of the Fermi energy. Therefore, rather than the replacement energy of the replacement electrons being equal to the chemical potential of the emitter electrode (402), the electron replacement process takes place in the available energy states below the Fermi energy in the emitter electrode (402). The process through which electrons are emitted above the Fermi level and are replaced with electrons below the Fermi energy is sometimes referred to as an inverse Nottingham effect. Accordingly, a low work function value of about 0.5 eV for the emitter electrode (402) allows for the replacement of the emitted electrons with electrons with a lower energy level to induce a cooling effect on the emitter electrode (402).

As described this far, the principal electron transfer mechanism for operation of the nano-scale energy harvesting device (400) is thermionic energy conversion or harvesting. In some embodiments, thermoelectric energy conversion is conducted in parallel with the thermionic energy conversion. For example and referring to FIG. 6, an electron (612) colliding with a nanoparticle cluster (604) and (606) with a first energy may induce the emission of two electrons at second and third energy levels, respectively, where the first energy level is greater than the sum of the second and third energy levels. In such circumstances, the energy levels of the emitted electrons are not as important as the number of electrons.

A plurality of nano-scale energy harvesting devices (400) is distinguished by at least one embodiment having the thermoelectric energy conversion features described herein. The nano-fluid (412), (602) is selected for operation of the nano-scale energy harvesting devices (400) within one or more temperature ranges. In an embodiment, the temperature range of the associated nano-scale energy harvesting device (400) is controlled to modulate a power output of the device (400). In general, as the temperature of the emitter electrode (402) increases, the rate of thermionic emission therefrom increases. The operational temperature ranges for the nano-fluid (602) are based on the desired output of the nano-scale energy harvesting device (400), the temperature ranges that optimize thermionic conversion, the temperature ranges that optimize thermoelectric conversion, and fluid characteristics. Therefore, different embodiments of the nano-fluid (602) are designed for different energy outputs of the device (400).

For example, in an embodiment, the temperature of the nano-fluid (412), (602) is maintained at less than 250° C. to avoid deleterious changes in energy conversion due to the viscosity changes of the dielectric medium (608) above 250° C. In an embodiment, the temperature range of the nano-fluid (602) for substantially thermionic emission only is approximately room temperature (i.e., about 20° C. to about 25° C.) up to about 70-80° C., and the temperature range of the nano-fluid (602) for thermionic and thermo-electric conversion is above 70-80° C., with the principle limitations being the temperature limitations of the materials. The nano-fluid (602) for operation including thermoelectric conversion includes a temperature range that optimizes the thermoelectric conversion through optimizing the power density within the nano-scale energy harvesting device (400), thereby optimizing the power output of the device (400). In at least one embodiment, a mechanism for regulating the temperature of the nano-fluid (602) includes diverting some of the energy output of the device (400) into the nano-fluid (602). Accordingly, the apertures (408) of specific embodiments of the nano-scale energy harvesting device (400) may be filled with the nano-fluid (602) to employ thermoelectric energy conversion with thermionic energy conversion above a particular temperature range, or thermionic energy conversion by itself below that temperature range.

As described herein, in at least one embodiment, the dielectric medium (608) has thermal conductivity values less than about 1.0 watt per meter-degrees Kelvin (W/m-K). In at least one embodiment, the thermal conductivity of the dielectric medium (608) is about 0.013 watt per meter-degrees Kelvin (W/m-K), as compared to the thermal conductivity of water at about 20 degrees Celsius (° C.) of about 0.6 W/m-K. Accordingly, the nano-fluid (602) minimizes heat transfer through the apertures (408) of FIG. 4 with low thermal conductivity values. Since the heat transport in a low thermal conductivity nano-fluid (602) can be small, a high temperature difference between the two electrodes (402) and (404) can be maintained during operation. These embodiments are designed for nano-scale energy harvesting devices, such as that shown and described in FIGS. 1-4, that employ thermionic emission where minimal heat transfer through the nano-fluid (412), (602) is desired.

As shown in FIG. 4, the nano-scale energy harvesting device (400) has an aperture (408) with a distance (410) between electrodes (402) and (404) that is within a range of about 1 nm to about 20 nm. In a portion of the electrode separation distance (410) of about 1 nm to about less than 10 nm, thermal conductivity values and electrical conductivity values of the nano-fluid (412), (602) are enhanced beyond those conductivity values attained when the predetermined distance of the cavity (408) is greater than about 100 nm. This enhancement of thermal and electrical conductivity values of the nano-fluid (412), (602) associated with the distance (410) of about 1 nm to 10 nm as compared to a distance (410) greater than 100 nm is due to a plurality of factors. Examples of a first factor include, but are not limited to, enhanced phonon and electron transfer between the plurality of nanoparticle clusters (604) and (606) within the nano-fluid (602), enhanced phonon and electron transfer between the plurality of nanoparticle clusters (604) and (606) and the first electrode (402), and enhanced phonon and electron transfer between the plurality of nanoparticle clusters (604) and (606) and the second electrode (404).

A second factor is an enhanced influence of Brownian motion of the nanoparticle clusters (604) and (606) in a confining environment between the electrodes (402) and (404) to, e.g., less than about 10 nm. As the distance (410) between the electrodes (402) and (404) decreases below about 10 nm, fluid continuum characteristics of the nano-fluid (412), (602) with the suspended nanoparticle clusters (604) and (606) is altered. For example, as the ratio of particle size to volume of the apertures (408) increases, random and convection like effects of Brownian motion in a dilute solution dominate. Therefore, collisions of the nanoparticle clusters (604) and (606) with the surfaces of other nanoparticle clusters (604) and (606) and the electrodes (402) and (404) increase thermal and electrical conductivity values due to the enhanced phonon and electron transfer.

A third factor is the at least partial formation of matrices of the nanoparticle clusters (604) and (606) within the nano-fluid (602). Under certain conditions, the nanoparticle clusters (604) and (606) will form matrices within the nano-fluid (602) as a function of close proximity to each other with some of the nanoparticle clusters (608) remaining independent from the matrices. In an embodiment, the formation of the matrices is based on the factors of time and/or concentration of the nanoparticle clusters (604) and (606) in the nano-fluid (602).

A fourth factor is the predetermined nanoparticle cluster (604) and (606) density, which in an embodiment is about one mole per liter. Accordingly, apertures (408) containing the nano-fluid (602) with a distance (410) of about 1 nm to less than about 10 nm causes an increase in the thermal and electrical conductivity values of the nano-fluid (602) therein.

In addition, the nanoparticle clusters (604) and (606) have a small characteristic length, e.g., about 2 nm, and they are often considered to have only one dimension. This characteristic length restricts electrons in a process called quantum confinement, which increases electrical conductivity. The collision of particles with different quantum confinement facilitates transfer of charge to the electrodes (402) and (404). The nano-scale energy harvesting device (400) has an enhanced electrical conductivity value greater than about 1 Siemens per meter (S/m) as compared to the electrical conductivity of drinking water of about 0.005 S/m to about 0.05 S/m. Also, the embodiments of device (400) with the enhanced thermal conductivity have a thermal conductivity value greater than about 1 W/m-K as compared to the thermal conductivity of water at 20 degrees Celsius (° C.) of about 0.6 W/m-K.

Thermionic emission of electrons (612) from the emitter electrode (402) and the transfer of the electrons (612) across the nano-fluid (602) from one nanoparticle cluster (604) and (606) to another nanoparticle cluster (604) and (606) through hopping are both quantum mechanical effects.

Release of electrons from the emitter electrode (402) through thermionic emission as described herein is an energy selective mechanism. A thermionic barrier in the apertures (408) between the emitter electrode (402) and the collector electrode (404) is induced through the interaction of the nanoparticles (604) and (606) with the electrodes (402) and (404) inside the apertures (408). The thermionic barrier is at least partially induced through the number and material composition of the plurality of nanoparticle clusters (604) and (606). The thermionic barrier induced through the nano-fluid (602) provides an energy selective barrier on the order of magnitude of about 1 eV. Accordingly, the nano-fluid (602) provides an energy selective barrier to electron emission and transmission.

To overcome the thermionic barrier and allow electrons (612) to be emitted from the emitter electrode (402) above the energy level needed to overcome the barrier, materials for the emitter electrode (402) and the collector electrode (404) are selected for their work function values and Fermi level values. The Fermi levels of the two electrodes (402) and (404) and the nanoparticle clusters (604) and (606) will try to align by tunneling electrons (612) from the electrodes (402) and (404) to the nanoparticle clusters (604) and (606). The difference in potential between the two electrodes (402) and (404) (described elsewhere herein) overcomes the thermionic barrier, and the thermionic emission of electrons (612) from the emitter electrode (402) occurs with sufficient energy to overcome the thermionic block. Notably, and in general, for cooling purposes, removing higher energy electrons from the emitter electrode (402) causes the emission of electrons (612) to carry away more heat energy from the emitter electrode (402) than is realized with lower energy electrons. Accordingly, the energy selective barrier is overcome through the thermionic emission of electrons at a higher energy level than would be otherwise occurring without the thermionic barrier.

Once the electrons (612) have been emitted from the emitter electrode (402) through thermionic emission, the thermionic barrier continues to present an obstacle to further transmission of the electrons (612) through the nano-fluid (602). Smaller gaps on the order of about 1 nm to about 10 nm as compared to those gaps in excess of 100 nm facilitates electron hopping, i.e., field emission, of short distances across the apertures (408). Energy requirements for electron hopping are much lower than the energy requirements for thermionic emission; therefore, the electron hopping has a significant effect on the energy generation characteristics of the device (400). The design of the nano-fluid (602) enables energy selective tunneling, e.g. electron hopping, that is a result of the barrier (which has wider gap for low energy electrons) which results in electrons above the Fermi level being a principal hopping component. The direction of the electron hopping is determined through the selection of the different materials for the electrodes (402) and (404) and their associated work function and Fermi level values. The electron hopping across the nano-fluid (602) transfers heat energy with electrons (612) across the apertures (408) while maintaining a predetermined temperature gradient such that the temperature of the nano-fluid (602) is relatively unchanged during the electron transfer. Accordingly, the emitted electrons transport heat energy from the emitter electrode (402) across the apertures (408) to the collector electrode (404) without increasing the temperature of the nano-fluid (602).

Referring to FIG. 7, a diagram (700) is provided illustrating a schematic perspective view of one embodiment of a nano-scale energy harvesting device (790). The device (790) is not shown to scale. The power harvesting device (790) is manufactured with a plurality of layers of materials. In an embodiment, the power harvesting device (790) is manufactured with four separate layers. A first layer (702) is referred to as a casing or sheathing that protects one or more of the inner layers and facilitates heat transfer in and out of the device (790). In an embodiment, the first layer (702) is manufactured from a thermally conductive and electrically insulating material. A second layer (704) includes the emitter electrode, a third layer (706) includes the separation material (also referred to herein as a standoff and spacer), and a fourth layer (708) includes the collector electrode. In an embodiment, the third layer (706) is referred to herein as a spacer. The emitter electrode (704), the spacer (706), and the collector electrode (708) are fabricated and configured as shown and described in FIGS. 4-6. The separation material (706), e.g., the third layer, contains nano-fluid, such as the nano-fluid (412) of FIG. 4 and (602) of FIG. 6, positioned in the apertures (408) and (506). The outer casing (702), e.g., the first layer, is in direct contact with the emitter electrode (704), e.g., the second layer, and the emitter electrode (704) and the collector electrode (708), e.g., the fourth layer, are in direct contact with the spacer (706). The layers (702), (704), (706), and (708) are shown peeled away for clarity. In an embodiment, the layers (702), (704), (706), and (708) define a composite structure configured as a sheet (710). Accordingly, the outer casing (702) is in contact with the emitter electrode (704) to provide heat transfer, protective, and sealing features to the device (790).

The thermionic power harvesting device (790) is shown herein with an at least partially planar configuration with a defined radius (712) extending from an end of an aperture (718) to an outermost surface (716) of the device (790). It should be understood that various configurations may be practiced, including the configuration of an aircraft wing as discuss above in connection with FIGS. 1-3. As shown herein, the aperture (718) has a planar or relatively planar geometric characteristic, and is hereinafter referred to as a planar aperture. The planar aperture (718) has geometric properties, including a first base area (720) and an opposing second base area (722), with the planar aperture extending from the first base area (720) to the second base area (722). In an embodiment, the distance between the first base area (720) and the second base area (722) is referred to as a first distance. In an embodiment, a structural member (724) is inserted into and received by the planar aperture (718). The structural member (724) is received by and positioned within the aperture (718). In an embodiment, the structural member (724) received by and positioned in the aperture (718) extends beyond the area defined by the aperture (718). In an embodiment, the structural member (724) is fabricated from one or more materials that are both thermally and electrically conductive, as well as chemically compatible with the materials of the layers (702), (704), (706), and (708). In other embodiments, the structural member (724) is fabricated from materials that are either thermally or electrically conductive. Accordingly, the structural member (724) is configured with mechanical and electrical properties. Although the structural member (724) is illustrated as a flat, e.g. planar, plate, it should be understood that the structural member (724) may have an airfoil shape of and aircraft wing skin similar to that of FIG. 2 or a fuselage similar to that of FIG. 3.

The fourth layer (708), e.g., the collector electrode, is electrically coupled to the structural member (724) to provide at least a partial electrical flow path. The composite layer (710) extends from the structural member (724) in a wrapped configuration, where the wrapped configuration has a common center defined by the planar aperture (718) to further define a concentric configuration. The planar aperture (718) further defines a toroidal configuration with respect to the wrapped configuration of the composite layer (710). Accordingly, the at least partially planar thermionic power harvesting device (790) has characteristics that are concentric and toroidal.

In an embodiment, the thermionic power harvesting device (790) has a first measurement (726), referred to as length, of approximately 10 mm to about 2.0 m, although greater lengths are contemplated. The radius (712) of device (790) can equal or approximate the radius of a conventional aircraft component, such as a wing. A thickness of the composite layer (710) (i.e., collective thickness of the layers (702), (704), (706), and (708)) is approximately 0.005 mm to about 2.0 mm. A thickness (730) of the collector electrode (708) is approximately 0.005 mm to less than 2.0 mm. A thickness (732) of the spacer (706) is approximately 1.0 nm to about 10 microns. A thickness (734) of the emitter electrode (704) is approximately 0.005 mm to less than 2.0 mm. A thickness (736) of the outer casing (702) is approximately 0.005 mm to less than 2.0 mm. The composite sheet (710) is defined by a first measurement, which is referred to as a composite length, ranging from approximately 10 mm to 2.0 m or more. Other embodiments include any dimensional characteristics that enable operation of the thermionic generation device (790) as described herein.

As further shown, an electrical circuit (750) is connected to the thermionic power harvesting device (790). The circuit (750) includes an electrical conductor (752) that is electrically connected to the structural member (724) that is electrically connected to the collector electrode (708). The circuit (750) further includes at least one load (756) connected to the conductor (752). The load (756) may be, for example, a capacitor. When the thermionic power harvesting device (790) is generating electricity, electrical current (758) (using conventional flow notation) is transmitted through the circuit (750) in an opposite direction to the electron current, and electrical current flows through the circuit (750) from the emitter electrode (704) to the collector electrode (708). For example, a single device (790) can generate a voltage within a range extending between about 0.5 volts and 1.0 volts, depending on the contact potential difference (discussed further herein) induced between the emitter electrode (704) and the collector electrode (708) as a function of the emitted and collector materials. In an embodiment, the device (790) generates about 0.90 volts. The device (790) can generate an electrical current within a range of approximately 5 amperes (amps) to approximately 10 amps. In an embodiment, the device (790) generates about 7.35 amps. Further, in one embodiment, the device (790) generates approximately 2.5 watts to approximately 10 watts. In one embodiment, the device (790) generates about 6.6 watts. A plurality of the devices (790) may be electrically connected in series for a specific voltage or in parallel for a specific current, or in series and parallel to satisfy both the voltage and current requirements. Accordingly, as described further herein, an arrangement of the devices (790) is scalable to provide sufficient electrical power from the watt range to the megawatt range for a variety of applications.

The structural member (724) performs both heat transfer and electrical conduction actions when the thermionic power harvesting device (790) is in service generating electricity. The structural member (724) is electrically coupled to the circuit (750) to transmit the electrical power generated within the device (790) to the load (756). The structural member (724) is shown herein operably coupled to a heat sink (760) through a heat transfer member (762). Specifically, the collector electrode (708) is in direct contact with the structural member (724). In an embodiment, the heat sink (760) and the heat transfer member (762) are energized to approximately the voltage of the energized structural member (724). In an embodiment, the heat transfer member (762) is fabricated from an electrically non-conductive material that has sufficient heat transfer characteristics to maintain the device (790) within a predetermined temperature range. In an embodiment, heat transfer member (762) is fabricated from, but not limited to, graphene, carbon composites, and similar materials.

The thermionic power harvesting device (790) generates electric power through harvesting heat energy (764). As described in further detail herein, the emitter electrode (704) receives heat energy (764) from sources that include, without limitation, heat generating sources and ambient environments, and generates the electric current (758) that (with reference to FIG. 5A) traverses the apertures (506) via (with reference to FIG. 6) the nanoparticle clusters (604) and (606) in the form of the electrons (612). The electric current (758) reaches the collector electrode (708) and the current (758) is transmitted through the circuit (750) to the power load(s) (756). The power load(s) (756) may be, for example, one or more capacitors, rechargeable batteries, electronics systems, sensors, hydraulics, black boxes, cameras, etc. In an embodiment, the device (790) generates electrical power through placement in ambient, room temperature environments. Accordingly, the device (790) harvests heat energy (764), including waste heat, to generate useful electrical power.

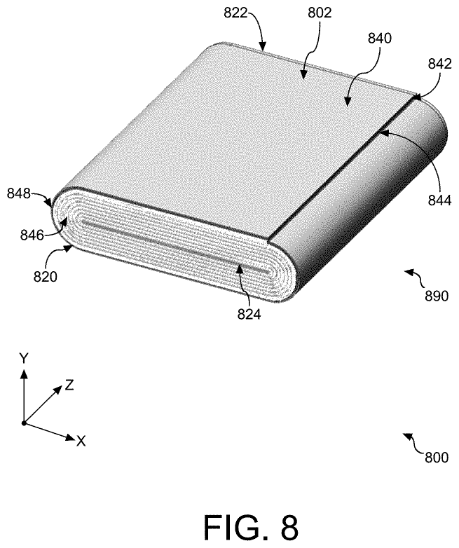

Referring to FIG. 8, a schematic drawing (800) is provided illustrating a perspective view of an thermionic power harvesting device (890). In an embodiment, the device (890) is similar to the device (790). In an embodiment, an outer casing (802) includes multiple layers (similar to layer 702 of FIG. 7) of outer casing material to fabricate the outer casing (802) with an enhanced robustness. The outer casing (802) of the device (890) includes an external surface (840) that includes a seam (842) defined by one or more layers (such as layer (702) of FIG. 7) of the outer casing (802). In an embodiment, the seam (842) is defined by a composite structure, such as the composite structure (710) of FIG. 7. The seam (842) is shown receiving a sealant (844) to prevent ingress of contaminants and egress of device materials through the seam (842). In an embodiment, the sealant (842) is non-conductive to prevent short circuiting, such as between the electrodes (704) and (708) of FIG. 7. In an embodiment, the sealant (844) is antimony-based. In another embodiment, the sealant (844) is manufactured from a material that enables operation of a thermionic power harvesting device (890) as described herein.

A first base area (820) receives a sealant (846) that extends between a rim (848) defined by the outer casing (802) and a structural member (824) that is similar to the structural member (724) described above. In an embodiment, the sealant (846) is substantially similar to the sealant (844) with respect to composition and function. In an embodiment, the sealant (846) is different from the sealant (844). The sealant (846) is also applied to a second base area (822), oppositely disposed from the first base area (820). In an embodiment, the second end area (822) has a similar configuration to the first base area (820). The sealant (846) functions to protect electrodes (e.g., the electrodes (704) and (708)), spacer (e.g., the spacer (706)), and nano-fluid (e.g., the nano-fluid (602)) from environmental factors, such as debris, that may induce a short circuit between electrodes (e.g., the electrodes (704) and (708)) or contaminate the nano-fluid (602).

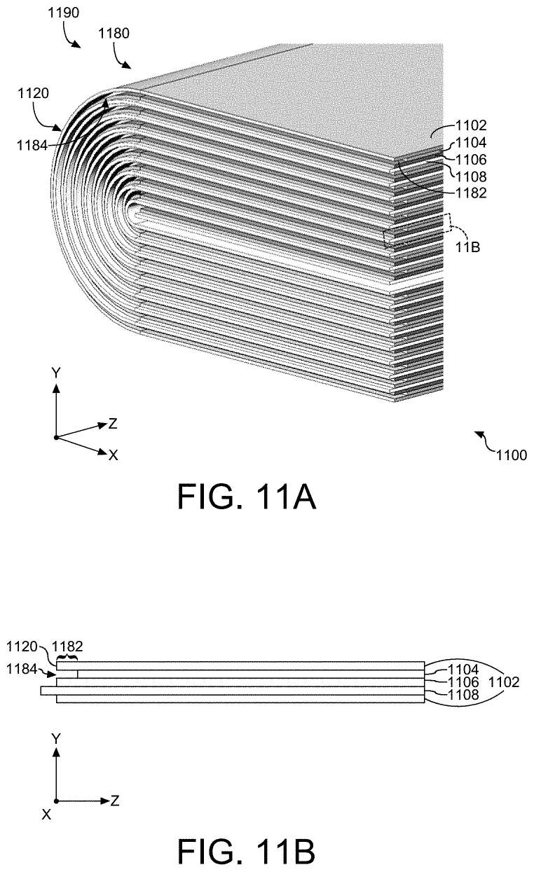

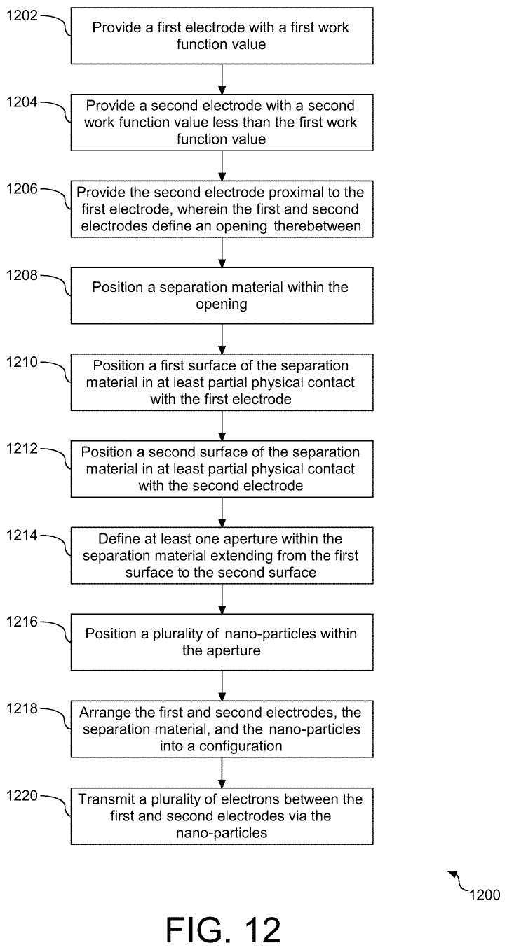

In addition, as described herein with respect to FIGS. 5A and 5B, and described further with respect to FIGS. 11A, 11B, and 12, the electrodes (704) and (708) (equivalent to the electrodes (562) and (564), respectively) are offset distances (equivalent to distances (536) and (548), respectively), from the edges (514) and (516) of the spacer (706). As shown in FIG. 8, the non-conducting sealant (846) resides around the lateral side edges (similar to side edges (530) of the electrode (562) and the lateral side edges (542) of the electrode (564)) that extend distances (equivalent to distances (536) and (548)) beyond the spacer (300), (370)), respectively. Accordingly, the thermionic power harvesting device (890) is shown herein with sealants (844) and (846) that provide environmental protection for the device (890) and electrical insulation for the electrodes (704) and (708).

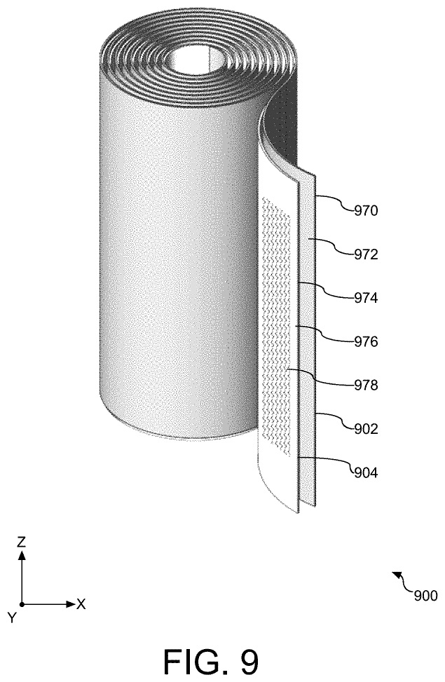

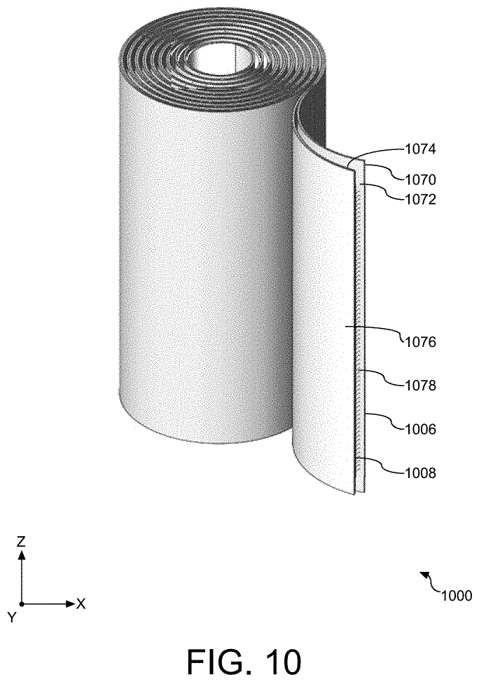

In an embodiment, the thermionic power harvesting devices (790) and (890) are manufactured from different pre-fabricated materials. FIG. 9 shows a perspective view of a first repository or roll (900) of layered materials (902) and (904), e.g., the first and second layers, that may be used to manufacture the thermionic power harvesting devices (790) and (890). FIG. 10 illustrates a perspective view of a second repository or roll (1000) of layered materials (1006) and (1008), e.g. the third and fourth layers, that may be used in combination with the first repository (900) to manufacture the thermionic power harvesting devices (790) and (890).

Referring to FIG. 9, a first layer (902) is equivalent to the outer casing (702) and is hereon referred to as outer casing (902). Similarly, a second layer (904) is equivalent to the emitter electrode (704) and is hereon referred to as emitter electrode (904). The outer casing (902) includes a first surface (970) that defines an external surface (840) of the thermionic power harvesting devices (790) and (890). The outer casing (902) also includes a second surface (972) that contacts the emitter electrode (904). The emitter electrode (904) includes a first surface (974) contacting the second surface (972) of the outer casing (902). The emitter electrode (904) also includes a second surface (976). In an embodiment, the second surface (976) is at least partially coated with Cs₂O (978), which in an embodiment is pre-applied to the second surface (976). In an embodiment, the Cs₂O (978) is applied to the second surface (976) during manufacturing of the thermionic power harvesting devices (790) and (890).

Referring to FIG. 10, a third layer (1006) is equivalent to the separation material (706), and is hereon referred to as separation material (1006). Similarly, a fourth layer (1008) is equivalent to the collector electrode (708) and is hereon referred to as collector electrode (1008). The separation material (1006) includes a first surface (1070) that contacts the second surface (976) of the emitter electrode (904) of FIG. 9. The separation material (1006) also includes a second surface (1072). The collector electrode (1008) includes a first surface (1074) contacting the second surface (1072) of the separation material (1006). The collector electrode (1008) also includes a second surface (1076). In an embodiment, the first surface (1074) is at least partially coated with Cs₂O (1078), which in an embodiment is pre-applied to the first surface (1074). In an embodiment, the Cs₂O (1078) is applied to the first surface (1074) during manufacturing of the thermionic power harvesting devices (790) and (890).

In an embodiment, rather than manufacturing the thermionic power harvesting devices (790) and (890) using the two repositories or rolls (900) and (1000), each of the layers (902), (904), (1006), and (1008) are dispensed from an individual repository or roll for each layer. In an embodiment, rather than using a separation material (1006) in the form of a solid material, the separation material (1006) is applied to either the second surface (976) of the emitter electrode (904) or the first surface (1074) of the collector electrode (1008). In an embodiment, the solid material is a sheet or a web. In an embodiment, the separation material (1006) is applied to both of the surfaces (976) and (1074). In an embodiment, the separation material (1006) is pre-applied to the electrodes (904) and (1008). In an embodiment, the separation material (1006) is applied to the electrodes (904) and (1008) at the time of manufacture of the devices (790) and (890). In an embodiment, the separation material (1006) is a fluid applied through one or more electrospray devices (not shown). In an embodiment, the separation material (1006) is applied through any method that enables operation of devices (790) and (890) as described herein.

Referring to FIGS. 11A and 11B, a diagram (1100) is provided illustrating an enlarged perspective view of a first portion (1180) of a thermionic power harvesting device (1190) according to an embodiment. The device (1190) is similar to devices (790) and (890). The outer casing (1102), the emitter electrode (1104), the spacer (1106), and the collector electrode (1108) are shown stacked on one another. FIG. 11B shows an offset (1182) of the emitter electrode (1104) with respect to the spacer (1106). The emitter electrode (1104) is recessed or offset in the Y-dimension with respect to the first base area (1120) at least partially defined by the outer casing (1102), the spacer (1106), and the collector electrode (1108). The depression or offset (1182) of the emitter electrode (1104) defines a cavity (1184) between each adjacent layer of the spacer (1106) and each adjacent layer of the outer casing (1102). In addition to the depression of the emitter electrode (1104), the collector electrode (1108) extends beyond the adjacent spacer (1106) in the Y-dimension. In an embodiment, rather than the emitter electrode (1104), the collector electrode (1108) is depressed or offset in the Y-dimension with respect to the first base area (1120). In an embodiment, an edge of the collector electrode (1108) is approximately flush, e.g., co-planar, with the edge of the spacer (1106) to partially define the first base area (1120) with no offset. As described herein with respect to FIG. 8, a sealant such as the sealant (846) of FIG. 8 is applied to the first base area (1120) to cover the edges of the emitter and collector electrodes (1104) and (1108), respectively, proximate the first base area (1120) and fill in the cavity (1184) with a non-conductive material to further electrical isolation between the electrodes (1104) and (1108).

Referring to FIG. 12, a flow chart (1200) is provided illustrating a process for generating electric power with the thermionic energy harvesting device. As described herein, a first electrode having a first work function value is provided (1202) and a second electrode having a second work function value is provided (1204). The work function value of the second electrode is less than the work function value of the first electrode. The first electrode and the second electrode are proximally positioned a predetermined distance from each other, i.e., about 1 nm to less than about 20 nm, to define an opening there between (1206). A separation material is positioned within the opening (1208). A first surface of the separation material is positioned in at least partial physical contact with the first electrode (1210), and a second surface of the separation material is positioned in at least partial physical contact with the second electrode (1212). At least one aperture is defined within the separation material, with the aperture extending from the first surface to the second surface (1214). A medium (e.g., nano-fluid) comprising a plurality of nanoparticles is positioned within the aperture(s) (1216). The first and second electrodes, the separation material, and the nanoparticles are arranged in a configuration (1218) corresponding to that of an aircraft structural component or a portion thereof, and a plurality of electrons is transmitted between the first and second electrodes via the nanoparticles (1220).

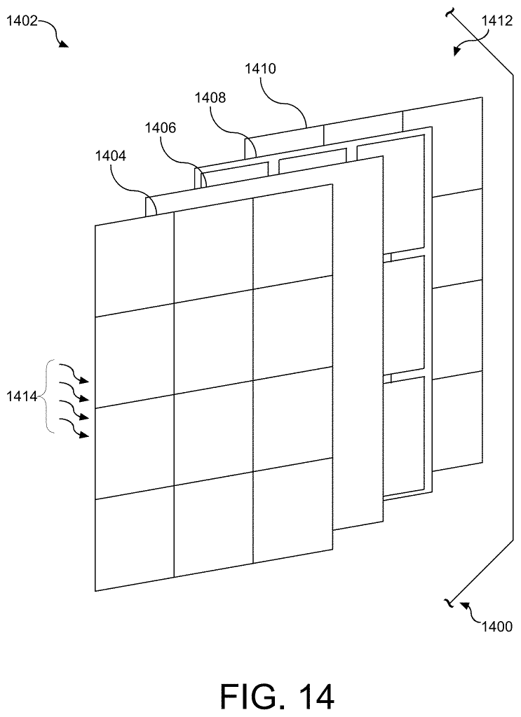

The nano-scale energy harvesting devices described herein can be integrated with or otherwise associated with multiple energy-harvesting devices to produce a greater energy-density device. The nano-scale energy harvesting devices described herein can be integrated with or otherwise associated with other heat and/or electrical sources. FIG. 14 shows an assembly (1402) including a first solar cell array (1404), a nano-scale energy harvesting device (1406), a load (1408), and a second solar cell array (1410) stacked on one another. The assembly (1402) is installed on an aircraft component (1412), which is illustrated in a fragmented view in FIG. 14. The nano-scale energy harvesting device (1406) is operatively associated with the first solar cell array (1406), the load (1408), and the second solar cell array (1410). For example, the nano-scale energy harvesting device (1406) may be 3D or 4D printed on the rear surface of the first solar cell array (1404) or the front surface of the load (1408). As the first solar cell array (1404) is heated by incident light, represented in FIG. 14 by curvy arrows (1414), the heat is transferred through the thermally conductive and electrically insulating material (e.g., 702 of FIG. 7) to the emitter electrode (e.g., 704 of FIG. 7). Likewise, heat may reflect off the surface of the aircraft component (1412) and be supplied to the energy harvesting device (1406). The aircraft component on which the assembly (1402) is positioned may be, for example, the aircraft wings, the fuselage, or other aircraft parts to receive sunlight. This association allows the nano-scale energy harvesting device (1406) to cool the solar cell arrays (1404) and (1410) by removing heat from the solar cells to improve photovoltaic production of the solar cell arrays (1404) and (1410), and synergistically generate power by providing the heat energy to the emitter electrode for conversion to electrical energy while improving solar cell efficiency. The load (1408) may be, for example, a circuit board containing capacitors.

As described herein, exemplary embodiments are directed generally to an energy source, and more particularly is directed to a nano-scale energy harvesting device. Ionization is provided therein by the combination of electron tunneling and thermionic emission of the nano-scale energy harvesting device. Charge transfer therein is affected through conductive nanoparticles suspended in a fluid, i.e., a nano-fluid, undergoing collisions driven by thermally-induced Brownian motion. The design of this device enables ambient energy extraction at low and elevated temperatures (including room temperature). To this end, the electrodes are proximally positioned to allow electrons to travel the distance between them. These electrons emitted at a wide range of temperatures proceed across the gap due to the nano-fluid providing a conductive pathway for the electron emission, reducing or minimizing heat transfer to maintain a nano-scale heat engine, and preventing arcing.

With respect to thermionic converters, the electrical efficiency of exemplary embodiments of these devices depends on low work function materials deposited on the emitter electrode (cathode) and the collector electrode (anode). The efficiency of two low work function electrodes can be increased by developing cathodes with sufficient thermionic emission of electrons operating even at room temperature. These low work function cathodes and anodes provide copious amounts of electrons. Similarly, a tunneling device includes two low work function electrodes separated by a designed nano-fluid. Cooling by electrode emission refers to the transport of hot electrons across the nano-fluid gap, from the object to be cooled (cathode) to the heat rejection electrode (anode). Thus, the coupling of several technologies, including: the electrospray-deposited two low work function electrodes include, for example, cesium-oxide on both tungsten and gold; an energy selective electron-transfer thermionic emission and quantum hopping of electrons; a nano-fluid that is tailored as a thermoelectric element to conduct electricity while minimizing heat transfer within the device; and thermal communication from the anode electrical connection that is in thermal contact with the device and the outside heat reservoir, produces a viable thermionic power generator according to an exemplary embodiment.

The nano-scale energy harvesting devices of exemplary embodiments described herein facilitate generating electrical energy via a long-lived, constantly-recharging, battery for any size-scale electrical application. The devices of exemplary embodiments provide a battery having a conversion efficiency superior to presently available single and double conversion batteries. In addition, the devices of exemplary embodiments described herein may be fabricated as an integral part of, and provide electrical energy for, an integrated circuit. The devices of exemplary embodiments described herein are a light-weight and compact multiple-conversion battery having a relatively long operating life with an electrical power output at a useful value. Furthermore, in addition to the tailored work functions, the nanoparticle clusters of exemplary embodiments described herein are multiphase nano-composites that include thermoelectric materials. The combination of thermoelectric and thermionic functions within a single device further enhances the power generation capabilities of the nano-scale energy harvesting devices.

The conversion of ambient heat energy into usable electricity enables energy harvesting capable of offsetting, or even replacing, the reliance of electronics on conventional power supplies, such as electrochemical batteries, especially when long-term operation of a large number of electronic devices in dispersed locations is required. Energy harvesting distinguishes itself from batteries and hardwire power owing to inherent advantages, such as outstanding longevity measured in years, little maintenance, and minimal disposal and contamination issues. The nano-scale energy harvesting devices described herein demonstrate a novel electric generator with low cost for efficiently harvesting thermal energy. The devices described herein initiate electron flow due to the differences in the Fermi levels of the electrodes without the need for an initial temperature differential or thermal gradient.

The nano-scale energy harvesting devices of exemplary embodiments described herein are scalable across a large number of power generation requirements. The devices may be designed for applications requiring electric power in the milliwatts (mW), watts (W), kilowatts (kW), and megawatts (MW) ranges. Accordingly, substantially any power demand in any situation associated with air travel and aircraft mission operations, particularly for SUAS, can be met with the devices disclosed herein.

Aspects of the present embodiments are described herein with reference to one or more of flowchart illustrations and/or block diagrams of methods and apparatus (systems) according to the embodiments.

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The implementation of the nano-scale energy harvesting devices as heat harvesting devices that efficiently convert waste heat energy to usable electric energy facilitates flexible uses of the minute power generators. Accordingly, the nano-scale energy harvesting devices and the associated embodiments as shown and described in FIGS. 1-14, provide electrical power through conversion of heat in most known environments, including ambient, ambient temperature environments.

The incorporation of an onboard energy harvesting device into a structural component of an aircraft can significantly improve mission performance and execution. For example, electric power is a limiting factor in air-borne military operations, sometimes require that the operations be terminated before their mission is completed due to depletion of conventional power sources such as electrochemical batteries. Deployment and recovery phases are time-intensive, limited by weather conditions, and can be hazardous to the military recovery operation and crew when the aircraft must be ditched before it returns to its home base. The energy harvesting structural aircraft components of exemplary embodiments described herein provide sustained, rechargeable energy that is not limited by flight duration or limitations of electrochemical batteries. For example, the onboard energy harvesting device can produce high energy output of, for example, greater than 550 watt-hours per kilogram, and even greater than 1550 watt-hours per kilogram.

Further, by incorporating the energy harvesting devices into the structural component(s) of the aircraft, structural integrity is provided without adding to the overall mass of the aircraft, particularly where one or more of the electrodes comprise graphene.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiments were chosen and described in order to best explain the principles of the embodiments and the practical application, and to enable others of ordinary skill in the art to understand the embodiments for various embodiments with various modifications and combinations with one another as are suited to the particular use contemplated.

It will be appreciated that, although specific embodiments have been described herein for purposes of illustration, various modifications may be made without departing from the spirit and scope of the embodiments. In particular, the nano-scale energy harvesting devices are shown as configured to harvest waste heat while in motion, in particular, during flight. The devices may also harvest heat from stationary or relatively stationary conditions. Accordingly, the scope of protection of the embodiment(s) is limited only by the following claims and their equivalents.

1. A flight vehicle structural component comprising:
a first electrode;
a second electrode spaced from the first electrode to provide an inter-electrode gap between the first and second electrodes; and
a plurality of nanoparticles suspended in a medium contained in the inter-electrode gap, the nanoparticles arranged in the inter-electrode gap to permit electron transfer between the first electrode and the second electrode,
the flight vehicle structural component operable as an energy harvesting device and configured to define a skin, a portion of the skin, a structural support, or a portion of the structural support of a flight vehicle.

2. The flight vehicle structural component of claim 1, wherein the flight vehicle structural component is configured to define the skin of or the portion of the skin of a flight vehicle.

3. The flight vehicle structural component of claim 2, wherein the skin has an airfoil shape.

4. The flight vehicle structural component of claim 2, wherein the skin is shaped as a fuselage of a flight vehicle.

5. The flight vehicle structural component of claim 1, wherein the flight vehicle structural component is configured to define the structural support or the portion of the structural support of the flight vehicle.

6. The flight vehicle structural component of claim 5, wherein the structural support comprises an internal strut of an aircraft wing, the internal strut having at least one surface or edge defining an airfoil shape.

7. The flight vehicle structural component of claim 6, wherein the flight vehicle structural component is configured as part of a fuselage of a flight vehicle.

8. The flight vehicle structural component of claim 1, wherein the first and second electrodes have first and second work function values, respectively, and further wherein the second work function value is less than the first work function value.

9. The flight vehicle structural component of claim 8, wherein the plurality of nanoparticles suspended in the medium collectively have a third work function value, and further wherein the third work function value is greater than the first and second work function values.

10. The flight vehicle structural component of claim 1, wherein the suspended nanoparticles comprise a conductive material with an alkanethiol coating.

11. The flight vehicle structural component of claim 1, wherein the first electrode or the second electrode comprises or both the first and second electrodes comprise graphene.

12. The flight vehicle structural component of claim 1, further comprising a spacer in the inter-electrode gap, the spacer defining openings containing the plurality of nanoparticles suspended in the medium.

13. The flight vehicle structural component of claim 1, wherein the flight vehicle structural component is integrated into the flight vehicle.

14. The flight vehicle structural component of claim 13, wherein the flight vehicle is a small unmanned air vehicle system.

15. An energy harvesting device comprising:
a first graphene electrode coated with a first layer comprised of a first material to provide the coated first graphene electrode with a first work function value;
a second graphene electrode spaced from the first graphene electrode to provide an inter-electrode gap between the first and second graphene electrodes, the second graphene electrode coated with a second layer comprised of a second material that is different than the first material to provide the coated second graphene electrode with a second work function value that is different than the first work function value; and
a plurality of nanoparticles suspended in a medium contained in the inter-electrode gap, the nanoparticles arranged in the inter-electrode gap to permit electron transfer between the first graphene electrode and the second graphene electrode.

16. The energy harvesting device of claim 15, wherein the energy harvesting device comprises a flight vehicle structural component configured to define a skin or a portion of the skin of a flight vehicle.

17. The energy harvesting device of claim 16, wherein the skin has an airfoil shape.

18. The energy harvesting device of claim 15, wherein the energy harvesting device is configured to define a structural support or the portion of the structural support of a flight vehicle.

19. The energy harvesting device of claim 18, wherein the structural support comprises an internal strut of an aircraft wing, the internal strut having at least one surface or edge defining an airfoil shape.

20. The energy harvesting device of claim 15, wherein at least one of the first layer or the second layer comprises sulfur covalently bonding the at least one of the first layer or the second layer to the first graphene electrode or the second graphene electrode, respectively.
